(19) United States
(12) Patent Application Publication
(10) Pub. No.: US 2024/0357048 A1
(43) Pub. Date: Oct. 24, 2024

(54) Color Correction Device, Printing System, Color Correction Method, And Non-Transitory Computer-Readable Storage Medium Storing Program

(71) Applicant: SEIKO EPSON CORPORATION, Tokyo (JP)

(72) Inventors: Takuya ONO, Shiojiri (JP); Takahiro KAMADA, Matsumoto (JP); Mitsuhiro YAMASHITA, Matsumoto (JP); Yuko YAMAMOTO, Shiojiri (JP)

(21) Appl. No.: 18/638,785

(22) Filed: Apr. 18, 2024

(30) Foreign Application Priority Data
Apr. 19, 2023 (JP) 2023-068303

(51) Int. Cl. H04N 1/60

(52) U.S. Cl. CPC H04N 1/6008; H04N 1/6058

(57) ABSTRACT

A color correction device includes: a color conversion unit configured to convert an input value in an input color space into an output value in an output color space; a selection unit configured to receive a selection, as a target color component, of one or more color components among a plurality of color components used in a printing device; and a correction unit configured to correct the output value in a manner of reducing the target color component when the input value represents a color not including the target color component. The correction unit reduces, when a specific multi-order color component different from the target color component is not included in the input value and the specific multi-order color component is included in the output value, the specific multi-order color component in the output value.

The present application is based on, and claims priority from JP Application Serial Number 2023-068303, filed Apr. 19, 2023, the disclosure of which is hereby incorporated by reference herein in its entirety.

### BACKGROUND

### 1. Technical Field

The present disclosure relates to a color correction device, a printing system, a color correction method, and a non-transitory computer-readable storage medium storing a program.

### 2. Related Art

In a typical printing device, printing is executed using four kinds of color materials, C (cyan), M (magenta), Y (yellow), and K (black). When the printing is performed, a color conversion for converting an input value in an input color space into an output value in an output color space is executed in a printing data generation device such as a personal computer. In the color conversion, a color component that is not present in the input value may appear in the output value. For example, when a patch formed of only a cyan color material is printed, even when the input value includes only a C component such as CMYK (90, 0, 0, 0), the output value may include an M component or a Y component such as CMYK (89, 1, 2, 0). Here, “CMYK (90, 0, 0, 0)” means C=90%, M=0, Y=0, and K=0. When the color component that is not present in the input value appears in the output value as described above, color turbidity and graininess may be perceived. In order to avoid such turbidity and graininess, a technique of “pure color protection” or “ink protection” is known in the related art in which, when an input color represented by the input value is a single color of any one of C, M, Y, and K, an output color represented by the output value is also made a single color.

JP-A-2018-082360 discloses an image processing device that performs a color purification process. The image processing device corrects, when an input color that is a primary color or a secondary color is multicolored by a color conversion, an output color to a primary color or a secondary color by performing the color purification process. The output color is corrected to reduce a color difference between the input color and the output color. The process of the primary color in the related art corresponds to the “pure color protection”.

JP-A-2018-082360 is an example of the related art.

However, in the related art, sufficient consideration may not be given to how to select an output value correction target in order to reduce color turbidity and graininess. In the related art, there is room for further improvement in order to reduce the color turbidity and the graininess.

### SUMMARY

According to a first aspect of the present disclosure, a color correction device is provided. The color correction device includes: a color conversion unit configured to convert an input value in an input color space into an output value in an output color space; a selection unit configured to receive a selection, as a target color component, of one or more color components among a plurality of color components used in a printing device; and a correction unit configured to correct the output value in a manner of reducing the target color component when the input value represents a color not including the target color component. The correction unit reduces, when a specific multi-order color component different from the target color component is not included in the input value and the specific multi-order color component is included in the output value, the specific multi-order color component in the output value.

According to a second aspect of the present disclosure, a printing system including a color correction device and a printing device is provided. The color correction device includes a color conversion unit configured to convert an input value in an input color space into an output value in an output color space, a selection unit configured to receive a selection, as a target color component, of one or more color components among a plurality of color components used in the printing device, a correction unit configured to correct the output value in a manner of reducing the target color component when the input value represents a color not including the target color component, and a printing data generation unit configured to generate printing data to be supplied to the printing device using a corrected output value corrected by the correction unit. The correction unit reduces, when a specific multi-order color component different from the target color component is not included in the input value and the specific multi-order color component is included in the output value, the specific multi-order color component in the output value.

According to a third aspect of the present disclosure, a color correction method is provided. The color correction method includes: (a) converting an input value in an input color space into an output value in an output color space; (b) receiving a selection, as a target color component, of one or more color components among a plurality of color components used in a printing device; and (c) correcting the output value in a manner of reducing the target color component when the input value represents a color not including the target color component. The (c) includes reducing, when a specific multi-order color component different from the target color component is not included in the input value and the specific multi-order color component is included in the output value, the specific multi-order color component in the output value.

According to a fourth aspect of the present disclosure, a non-transitory computer-readable storage medium storing a program is provided. The computer program causes a computer to execute: (a) a process of converting an input value in an input color space into an output value in an output color space; (b) a process of receiving a selection, as a target color component, of one or more color components among a plurality of color components used in a printing device; and (c) a process of correcting the output value in a manner of reducing the target color component when the input value represents a color not including the target color component. The process (c) includes a process of reducing, when a specific multi-order color component different from the target color component is not included in the input value and the specific multi-order color component is included in the output value, the specific multi-order color component in the output value.

### BRIEF DESCRIPTION OF THE DRAWINGS

FIG. 1 is a diagram showing a configuration of a printing system.

FIG. 2 is a diagram showing an example of a configuration of an image processing device.

FIG. 3 is a diagram showing another example of the configuration of the image processing device.

FIG. 4 is a diagram showing still another example of the configuration of the image processing device.

FIG. 5 is a diagram showing an example of a color conversion lookup table.

FIG. 6 is a diagram showing an example of occurrence of graininess due to a color conversion and non-input-color removal.

FIG. 7 is a diagram showing a comparison between pure color protection in the related art and the non-input-color removal in the present disclosure.

FIG. 8 is a diagram showing an example of selecting a target color component.

FIG. 9 is a diagram showing a processing example of the non-input-color removal when an input color space and an output color space are CMYK.

FIG. 10 is a diagram showing a processing example of the non-input-color removal when the input color space is RGB and the output color space is CMYK.

FIG. 11 is a flowchart showing an overall procedure of a color correction process.

FIG. 12 is a flowchart showing a processing procedure of step S30 in a first embodiment.

FIG. 13 is a flowchart showing a processing procedure of step S30 in a second embodiment.

FIG. 14 is a flowchart showing a processing procedure of step S110 in the second embodiment.

FIG. 15 is a diagram showing an example of a color correction process according to the second embodiment.

FIG. 16 is a diagram showing a processing example of non-input-color suppression when an input color space and an output color space are CMYK according to a third embodiment.

### DESCRIPTION OF EMBODIMENTS

### First Embodiment

### Configuration of Device

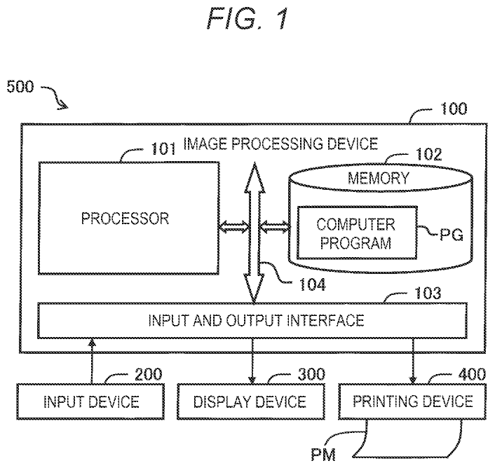

FIG. 1 is a diagram showing a configuration of a printing system 500 according to an embodiment. The printing system 500 includes an image processing device 100, an input device 200, a display device 300, and a printing device 400. The image processing device 100 corresponds to a “color correction device” in the present disclosure.

The image processing device 100 includes a processor 101, a memory 102, an input and output interface 103, and an internal bus 104. The processor 101, the memory 102, and the input and output interface 103 are coupled via the internal bus 104 so as to be able to communicate in both directions. The memory 102 includes a volatile memory including a main memory and a video memory, and a nonvolatile memory such as a hard disk and a solid state drive (SSD). The input device 200, the display device 300, and the printing device 400 are coupled to the input and output interface 103 of the image processing device 100 by wired communication or wireless communication. The input device 200 is, for example, a keyboard or a mouse. The display device 300 is, for example, a liquid crystal display. The input device 200 and the display device 300 may be integrated as a touch panel. The printing device 400 is, for example, an inkjet printer, and prints an image on a printing medium PM using a plurality of kinds of ink. The printing device 400 may be implemented as a digital textile printing machine that prints an image on a fabric printing medium PM.

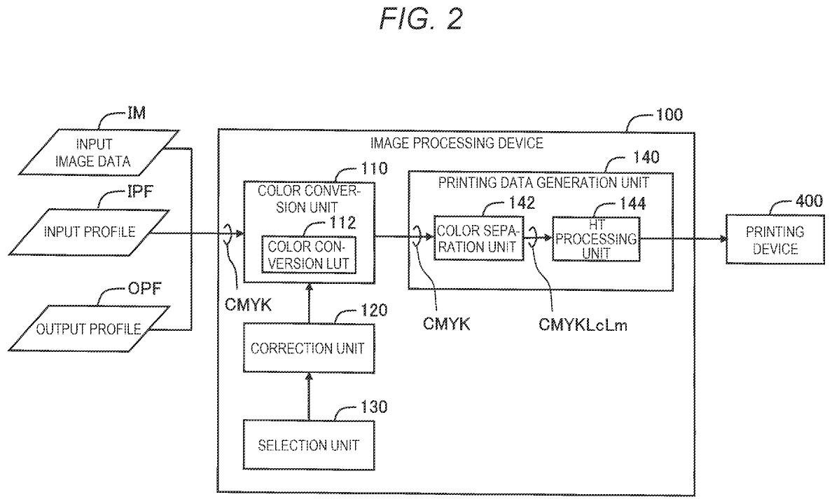

FIG. 2 is a diagram showing an example of a configuration of the image processing device 100. The image processing device 100 includes a color conversion unit 110, a correction unit 120, a selection unit 130, and a printing data generation unit 140. Functions of these units are implemented by software by the processor 101 executing a computer program PG stored in advance in the memory 102. Some of the functions of the units may be implemented by hardware circuits.

The color conversion unit 110 uses a color conversion lookup table 112 to execute a color conversion process of converting an input value in an input color space into an output value in an output color space. The color conversion lookup table 112 is created by combining an input profile IPF and an output profile OPF. The input profile IPF is an ICC profile used for a color conversion from the input color space used in input image data IM to a device-independent color space. The input color space is, for example, an RGB color space or a CMYK color space. The device-independent color space is, for example, a CIE-L⁺a⁺b⁺color space or a CIE-XYZ color space. The output profile OPF is an ICC profile used for a color conversion from the device-independent color space to the output color space for the printing device 400. As the output color space, various color spaces such as a CMYK color space and a CMYKRG color space can be used. The “CMYKRG color space” is a color space including six color components, C (cyan), M (magenta), Y (yellow), K (black), R (red), and G (green). A color in the output color space is also referred to as a “device color”. In the example in FIG. 2, both the input color space and the output color space are CMYK color spaces.

The correction unit 120 executes a color correction process to be described later. The color correction process is a process of correcting, when an input value represents a color not including a target color component, an output value so as to reduce the target color component. The selection unit 130 receives a selection of a user related to the target color component that is a target of color correction. As the target color component, for example, one or more color components are selected from a plurality of color components CMYK in the device color.

The printing data generation unit 140 uses a corrected output value corrected by the correction unit 120 to generate printing data to be supplied to the printing device 400. The printing data generation unit 140 includes a color separation unit 142 and a halftone processing unit 144. The color separation unit 142 converts an output value of each pixel of the input image data IM converted by the color conversion unit 110 into density values of a plurality of color materials of the printing device 400. In the example in FIG. 2, the printing device 400 uses color materials Lc (light cyan) and Lm (light magenta) in addition to CMYK, and the color separation unit 142 converts output values CMYK of each pixel into density values of six color materials CMYKLCLm. The halftone processing unit 144 generates printing data by performing a halftone process using a density value of each pixel after color separation. The printing device 400 executes printing according to the printing data transmitted from the printing data generation unit 140.

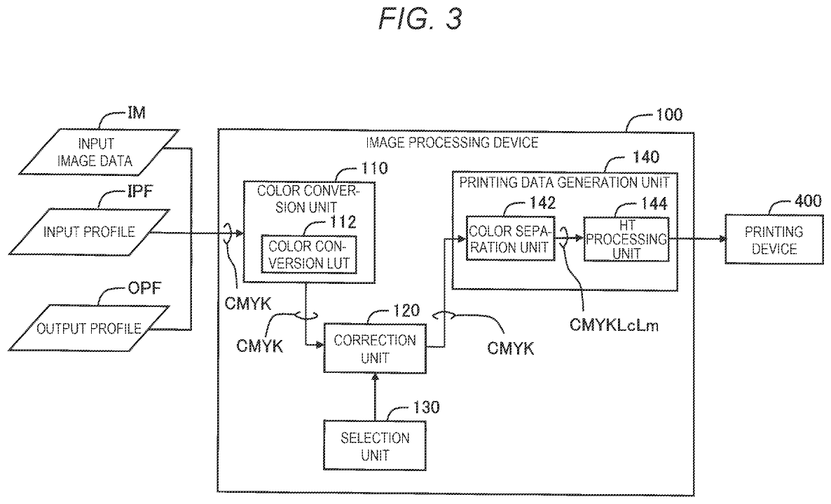

FIG. 3 is a diagram showing another example of the configuration of the image processing device 100. In this example, the correction unit 120 corrects the output values CMYK converted by the color conversion unit 110, and transmits the corrected output values to the halftone processing unit 144. In this case as well, one or more color components among the plurality of color components CMYK in the device color can be selected as the target color component that is the target of the color correction.

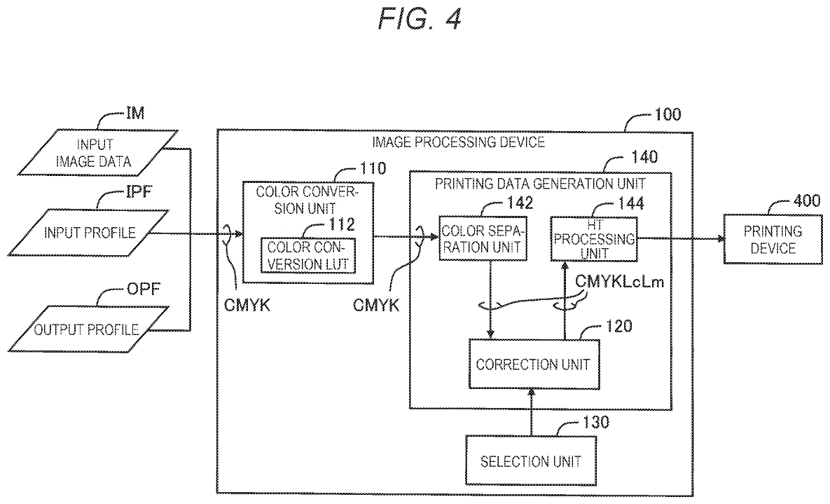

FIG. 4 is a diagram showing still another example of the configuration of the image processing device 100. In this example, the correction unit 120 corrects the density values of the color materials CMYKLcLm converted by the color separation unit 142, and transmits the corrected density values to the halftone processing unit 144. In this case, the density values of the color materials CMYKLCLm correspond to “output values after color conversion”. One or more color materials among the six color materials CMYKLcLm can be selected as the target color component that is the target of the color correction.

When the target color component is an Lc component, the Lc component that is not present in the input color space CMYK. In this case, as a method for determining a value of the target color component Lc in the input value CMYK, any one of the following two methods can be used.

### 1. First Method

A first method is a method for considering that the target color component Lc is not in the input value CMYK when a value of a C component in the input value CMYK is 0 or equal to or greater than a threshold value, and for considering that the target color component Lc is in the input value CMYK when the value of the C component in the input value CMYK is a positive value less than the threshold value. As the threshold value, for example, a value of 15% to 25% can be used.

### 2. Second Method

A second method is a method for considering the value of the target color component Lc in the input value CMYK as 0 regardless of actual values of the input values CMYK.

The selection unit 130 may be configured to receive from the user a selection of which of these methods to use.

As can be understood from the examples in FIGS. 2 to 4, as a “plurality of color components used in the printing device” selectable as the target color component, a plurality of color components of the device color may be used, or a plurality of color components corresponding to a plurality of color materials in the printing device may be used. In the following description, a case where the color component of the device color is selected as the target color component mainly using the configuration described in FIG. 2 will be described.

### Definition of Terms

Input color: a color represented by an input value of color conversion.
Output color: a color represented by an output value of color conversion.
Pure color protection: a process of correcting an output value of color conversion when an input value includes only color components of primary colors such as C, M, and Y to only color components of the same primary colors as the input value, which is a type of color correction in the related art.
C protection: pure color protection of cyan.
Non-input-color removal: a type of color correction according to the present disclosure, and a color component that is not present in a color represented by an input value is removed from an output value.
C removal: non-input-color removal of cyan.
Color removal plane: a plane defined by an input value in which one target color component is 0.
Non-input-color suppression: one type of color correction according to the present disclosure, in which a color component that is not present in a color represented by an input value is reduced from an output value.
Target color component: a color component selected as a target of non-input-color removal or non-input-color suppression.
Specific multi-order color component: a multi-order color component that is subject to correction same as a target color component when non-input-color removal or non-input-color suppression is executed. For example, a K component or an R component is the specific multi-order color component. The specific multi-order color component is a color component different from the target color component, and is a color component indicating, as a single color, a multi-order color including two or more color components including the target color component.
Specific multi-order color removal: color correction for removing a specific multi-order color component from an output value.
Primary color: a color including one color component among CMY components in subtractive color mixing, and a color including one color component among RGB components in additive color mixing.
Secondary color: a color including two color components.
Tertiary color: a color including three color components.
Pure K: black represented only by K and represented by CMYK (0, 0, 0, k) . . . . Composite K: black represented only by CMY components and represented by CMYK (c, m, y, 0). •Rich K: black represented by using all CMYK components and represented by CMYK (c, m, y, k).

In the present disclosure, a range of each color component is 0 to 100%. White and black are represented as follows, for example.
CMYK (0, 0, 0, 0): white
CMYK (100, 100, 100, 100): black
RGB (0, 0, 0): black
RGB (100, 100, 100): white

### Content of Color Correction Process

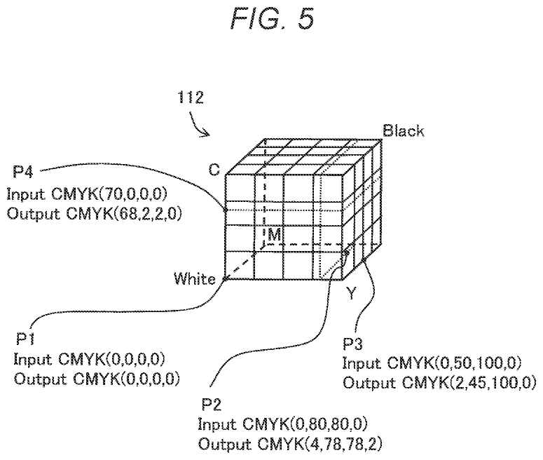

FIG. 5 is a diagram showing an example of the color conversion lookup table 112. Here, it is assumed that both the input color space and the output color space are CMYK. In FIG. 5, it is assumed that K=0, and a three-dimensional color solid including three color components CMY of the input value is drawn. An origin of the color solid is white (paper white), and is defined by three coordinate axes of a C-axis, an M-axis, and a Y-axis orthogonal to each other. A plurality of grid points are set in the color solid. In FIG. 5, only main grid lines and grid points are drawn for convenience of illustration. Each of the plurality of grid points of the color solid represents an input color. The color conversion lookup table 112 is a table in which output values are registered for input values corresponding to coordinate values of each grid point. In this example, for four grid points P1 to P4, input values CMYK (0, 0, 0, 0), CMYK (0, 80, 80, 0), CMYK (0, 50, 100, 0), and CMYK (70, 0, 0, 0), and output values CMYK (0, 0, 0, 0), CMYK (4, 78, 78, 2), CMYK (2, 45, 100, 0), and CMYK (68, 2, 2, 0) corresponding thereto are shown. The input value and the output value of the color conversion represent the same color in a device-independent color space such as the CIE-L⁺a⁺b⁺ color space or the CIE-XYZ color space, but a color component that is not present in the input value may appear in the output value. In this case, color turbidity and graininess may occur in an image reproduced by the output value.

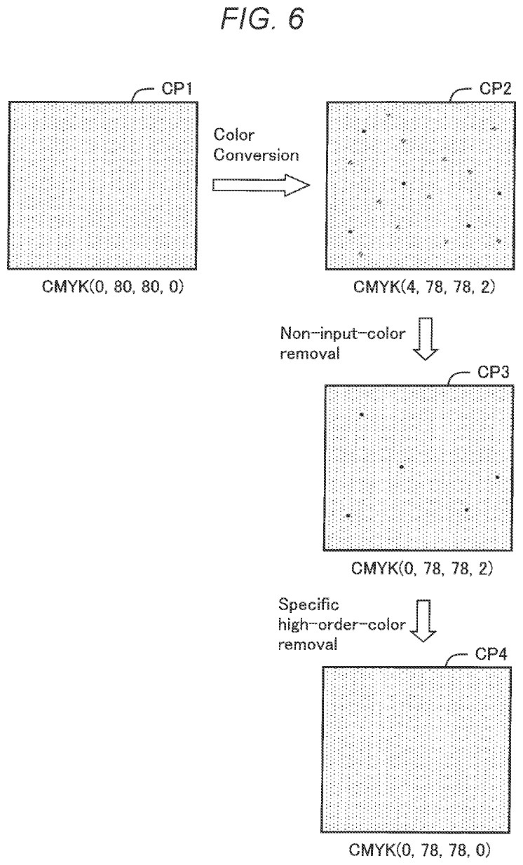

FIG. 6 is a diagram showing an example of generation of graininess and non-input-color removal by color conversion. In this example, a first color patch CP1 represented by the input values CMYK (0, 80, 80, 0) of the grid point P2 in FIG. 5 and a second color patch CP2 reproduced by the output values CMYK (4, 78, 78, 2) after the color conversion are drawn. The first color patch CP1 is formed of a single color of yellow. Meanwhile, in the second color patch CP2, since the output values include 4% of the C component and 2% of the K component, cyan ink dots and black ink dots are sparsely formed. In the second color patch CP2, since a color material other than yellow is mixed, color turbidity and graininess may be perceived.

In particular, when the printing medium PM is a cloth, color turbidity becomes a major problem. For example, when the printing medium PM made of cloth is used to create printed matters such as point of purchase advertising (POP), a poster, and apparel, a printed image is required to be uniform and smooth, and thus color turbidity in an image region having a uniform color becomes a problem. Therefore, when the printing medium PM made of cloth is used, it is particularly desirable to prevent occurrence of color turbidity.

The non-input-color removal, which is a type of color correction according to the present disclosure, is a process of removing, from an output value, a target color component that is not in a color represented by an input value. When the C component is selected as the target color component and the non-input-color removal is applied to the output values CMYK (4, 78, 78, 2), the C component not in the input values CMYK (0, 80, 80, 0) is removed from the output value, and corrected output values CMYK (0, 78, 78, 2) are obtained. Since a color patch CP3 reproduced by the corrected output values CMYK (0, 78, 78, 2) is not formed with the cyan ink dots, color turbidity and graininess is lower than those of the second color patch CP2. However, in the third color patch CP3, since the black ink dots are still formed, color turbidity and graininess may be perceived. In the embodiment, the corrected output values CMYK (0, 78, 78, 0) is obtained by further correcting the K component for the corrected output values CMYK (0, 78, 78, 2) after the non-input removal. Since a color patch CP4 reproduced by the corrected output values CMYK (0, 78, 78, 0) is reproduced only by yellow, no color turbidity and graininess occurs.

In the embodiment, when the non-input removal is performed with at least one of the C component, the M component, and the Y component as the target color component, the K component is also removed, thereby preventing the occurrence of color turbidity and graininess. In this case, the K component corresponds to the “specific multi-order color component” in the present disclosure.

However, when the K component of the input value CMYK is not 0, it is preferable not to perform the correction related to the output value. This is because of the following two reasons.

The first reason is that, even when the correction related to the output value is performed when the K component of the input value CMYK is not 0, it is difficult to obtain an effect of reducing color turbidity and graininess. That is, when the K component is included in the input value CMYK, it is difficult to obtain the effect of reducing the color turbidity and the graininess even when the target color component such as the C component is removed. When the K component of the input value CMYK is not 0, it is preferable to skip the non-input-color removal related to the target color component and the K component removal. Specifically, for example, when the input values CMYK (0, 80, 80, 50) are subjected to the color conversion to obtain the output values CMYK (2, 78, 78, 50), the output values CMYK (2, 78, 78, 50) are used as they are without performing the non-input removal related to the C component. In this way, the correction is skipped when the effect of reducing the color turbidity and the graininess is small, and thus the process can be speeded up.

The second reason is that, when the K component of the input values CMYK is not 0 and the output values CMYK represent composite K, when the non-input-color removal in which the C component is the target color component is performed, the color greatly changes. For example, when input values CMYK (0, 40, 40, 50) are subjected to the color conversion to obtain output values CMYK (50, 95, 95, 0), the output value represents the composite K. When the non-input-color removal in which the C component is the target color component is executed on the output values CMYK (50, 95, 95, 0), the corrected output values become CMYK (0, 95, 95, 0) and become a completely different color from the input values CMYK (0, 40, 40, 50). In order to prevent such a failure, it is preferable not to perform the correction related to the output values when the K component of the input values CMYK is not 0.

As the specific multi-order color component, in addition to the K component, it is also possible to use an R (red) component, a G (green) component, and an Or (orange) component. The K component is a color component that represents a tertiary color including three color components C, M, and Y as a single color. The R component is a color component that represents a secondary color including two color components M and Y as a single color. The G component is a color component that represents a secondary color including two color components C and Y as a single color. The Or component is a color component that represents a secondary color including two color components M and Y as a single color. As can be understood from these examples, the specific multi-order color component is a color component indicating, as a single color, a multi-order color including two or more color components including the target color component of the non-input-color removal.

As a combination of the target color component of the non-input-color removal and the specific multi-order color component, the following various combinations can be used.

(1) When the output color space is CMYK, the target color component is one or more of C, M, and Y, and the specific multi-order color component is the K component.

(2) When the output color space is CMYR, the target color component is one or more of M and Y, and the specific multi-order color component is the R component.

(3) When the output color space is CMYKR, the target color component is one or more of C, M, and Y, and the specific multi-order color component is one or more of K and R components. In this case, the non-input-color removal in which the C component is the target color component is preferably executed only when the K component of the input value is 0. The non-input-color removal in which the M component or the Y component is the target color component is preferably executed only when both the R component and the K component of the input value are 0.

(4) When the output color space is CMYOr, the target color component is one or more of M and Y, and the specific multi-order color component is the Or (orange) component.

When the output color space includes a plurality of multi-order color components as in the CMYKR color space, the user preferably selects one or more of the C, M, and Y components as the target color component and selects one or more of the plurality of multi-order color components as the specific multi-order color component.

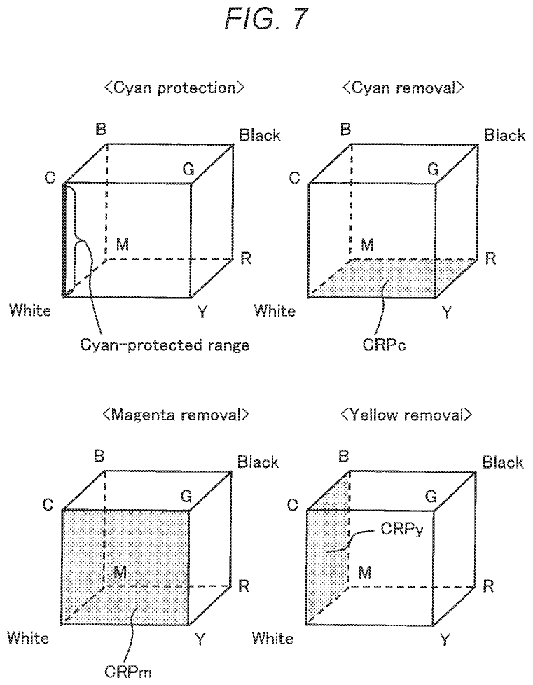

FIG. 7 is a diagram showing a comparison between pure color protection in the related art and the non-input-color removal in the present disclosure. Here, C protection is shown as an example of the pure color protection in the related art. The input color as a target of the C protection is a color of a grid point on the C-axis indicated by a thick line in an upper left diagram in FIG. 7. The C protection is correction for converting an output value at a grid point of the input values CMYK (c, 0, 0, 0) to CMYK (c′, 0, 0, 0).

FIG. 7 further shows target regions of C removal, M removal, and Y removal as the non-input-color removal according to the present disclosure. The non-input-color removal is performed on an input color of a grid point group that is present at a surface of the color solid. In the case of the C removal, a grid point group in which the C component in the input value is 0 is a target, and a hatched MY surface is a target of the non-input-color removal. The MY surface is referred to as a “color removal plane CRPC”. The color removal plane CRPc is a plane defined by an input value having the C component of 0. In the example in FIG. 6 described above, when the C removal is applied to the output values CMYK (4, 78, 78, 2), the C component not in the input values CMYK (0, 80, 80, 0) are removed from the output value, and the K component is also removed from the output value, and the corrected output values CMYK (0, 78, 78, 0) are obtained. The same applies to the M removal and the Y removal. That is, in the M removal, a CY plane becomes a color removal plane CRPm that is a target region of the non-input-color removal, and in the Y removal, a CM plane becomes a color removal plane CRPy that is a target region of the non-input-color removal. The CMYK color space is a four-dimensional color space, and for example, the color removal plane CRPc in which the C component in the input values is 0 constitutes a hyperplane of the four-dimensional space. Since it is difficult to show such a hyperplane, the hyperplane is represented by a plane of a three-dimensional space in FIG. 7.

In the present disclosure, the user can freely select a target color component that is a target of the non-input-color removal. For example, when the M removal and the Y removal are used in combination, the M component and the Y component are removed from an output value of the grid point on the C-axis, and only the C component remains.

It is also possible to apply K removal in which the target color component in non-input-color removal is K (black). For example, when input values CMYK (20, 20, 20, 0) are converted into output values CMYK (18, 18, 18, 2) by color conversion, the corrected output values CMYK (18, 18, 18, 0) can be obtained by applying the K removal. In this example, the input values CMYK (20, 20, 20, 0) are the composite K, but the output values CMYK (18, 18, 18, 2) are the mixed rich K for K. When the K removal is applied to this example, the corrected output values CMYK (18, 18, 18, 0) become the composite K. As a result, by not using K ink, it is possible to express uniform solid gray without graininess. In this example, the non-input-color removal is applied to the tertiary color. However, in the embodiment, for the reasons described above, when the K component of the input values CMYK is not 0, the correction related to the output values is not performed.

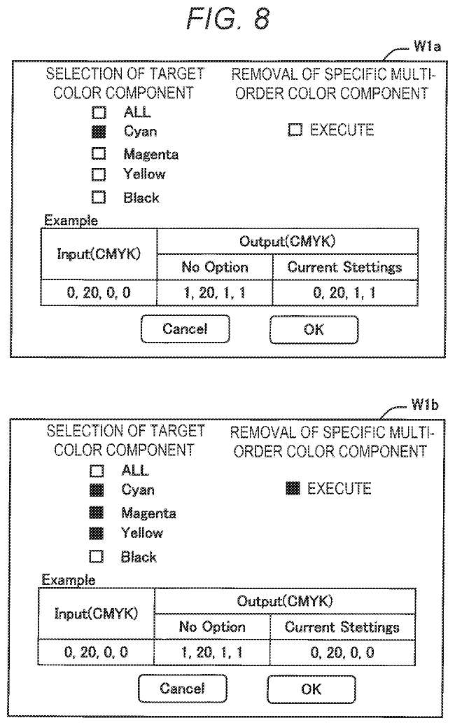

FIG. 8 is a diagram showing an example of selecting a target color component. The selection unit 130 causes the user to select a target color component by displaying a selection window on the display device 300. In a first selection window W1a, cyan is selected as the target color component. This means that only the C component is selected as the target color component. In a lower part of the selection window W1a, an input value and an output value of a processing example are shown. “NO Option” is an example of the output value when non-input-color removal is not applied. “Current Settings” is an example of a corrected output value when non-input-color removal is applied to a selected target color component. In the processing example of the selection window W1a, the C component is corrected to 0 by applying the non-input-color removal. In a second selection window W1b, cyan, magenta, and yellow are selected as the target color components. In a processing example of the selection window W1b, non-input-color removal is applied to the C component and the Y component to correct the C component and the Y component to 0. The reason why the K component is corrected to 0 is that a removal process related to the specific multi-order color component is executed. The processing example may be omitted.

Further, in the first selection window W1a, it is designated that the removal process related to the specific multi-order color component is not executed, and in the second selection window W1b, it is designated that the removal process related to the specific multi-order color component is executed. When it is designated that the removal process related to the specific multi-order color component is not to be executed, the removal process related to the specific multi-order color component is skipped even when the non-input removal for the target color component is executed. In the example of FIG. 8, although the user can designate whether to execute the removal process related to the specific multi-order color component, the correction unit 120 may determine whether to execute the removal process related to the specific multi-order color component according to the input value and the output value without receiving a designation from the user. When the output color space includes a plurality of multi-order color components, it is preferable that the user can select one or more of the plurality of multi-order color components as the specific multi-order color component.

The non-input-color removal in the present disclosure is also applicable to a case where a color material used in the printing device 400 is other than CMYK. For example, it is assumed that the printing device 400 executes printing using six color materials, C (cyan), M (magenta), Y (yellow), K (black), R (red), and G (green). In this case, any one or more of the six color components CMYKRG can be selected as the target color component for the non-input-color removal. Specifically, when input values CMYKRG (10, 10, 10, 10, 0, 0) are converted into output values CMYKRG (10, 10, 10, 10, 2, 2) by color conversion, and when two or more color components including an R component and a G component are selected as the target color components, the output values can be corrected to CMYKRG (10, 10, 10, 10, 0, 0).

Generally, when N is an integer of 3 or more, it is preferable that the selection unit 130 is configured to receive a selection, as the target color components, of any one or more and N or less color components among N color components corresponding to N color materials used in the printing device 400. In particular, it is preferable that three or more color components can be freely selected as the target color components. In this way, the color correction process can be executed for a desired number of target color components from one to N.

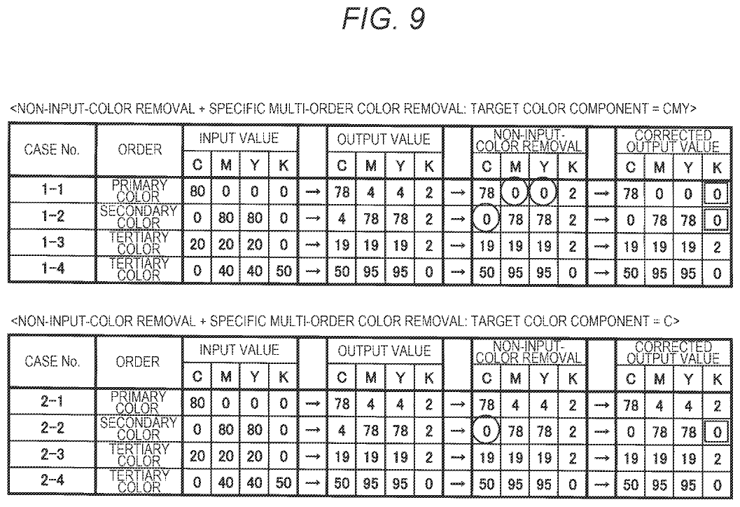

FIG. 9 is a diagram showing a processing example of the non-input-color removal when an input color space and an output color space are CMYK. Here, processing results are shown for three cases of a case in which three color components of “CMY” are selected as the target color components, and a case in which only “C” is selected as the target color component. When the input color is the primary color, the secondary color, and the tertiary color, a processing result thereof is shown. The “non-input-color removal” is an output value after the non-input-color removal. Circled numbers in the “non-input-color removal” are values of color components changed due to the non-input-color removal. The “corrected output value” is an output value after removal of the specific multi-order color component. Numbers surrounded by double frames in the “corrected output value” are values of the color components changed due to the removal of the specific multi-order color components. In cases 1-1, 1-2, and 2-2, both the non-input-color removal and the removal of the specific multi-order color component are performed. In cases 1-4 and 2-4, the target color components of the non-input-color removal are values other than 0 in the output value, whereas the K component as the specific multi-order color component is not 0 in the input value, and thus the correction on the output value is skipped. In cases 1-3, 2-1, and 2-3, since the target color components of the non-input-color removal are not 0 in the input value, the non-input-color removal is not executed, and the specific multi-order color component is not removed. As can be understood from this example, by the user selecting the target color component, the correction for the output value can be executed for any color component.

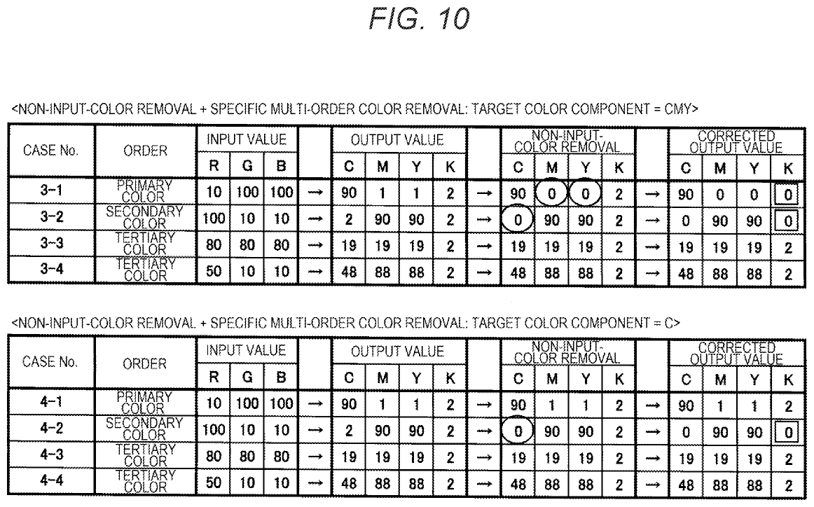

FIG. 10 is a diagram showing a processing example of the non-input-color removal when the input color space is RGB and the output color space is CMYK. When the target color component is one or more of the CMY components and the input color space is RGB, values of CMY components in the input values can be considered as equal to CMY values obtained by converting input values RGB by the following conversion formula.

$$\begin{matrix}Ci = ( 1 - Ri ) & ( q1 ) \\ Mi = ( 1 - Gi ) & ( q 2 ) \\ Yi = ( 1 - Bi ) & ( q 3 )\end{matrix}$$

Here, Ri, Gi, and Bi are color components in the input values, and Ci, Mi, and Yi are CMY components corresponding to RGB components in the input value. Ri, Gi, Bi, and Ci, Mi, Yi are values in a range of 0 to 1, and the value “1” corresponds to 100%.

A value of the K component in the input values RGB can be determined by any of the following methods.

### 1. Method M1a:

A value Ki of the K component in the input value RGB is determined according to the following formula.

$$Ki = min ( Ci , Mi , Yi ) \qquad ( q4 )$$

### 2. Method M1b:

The K component is considered as 0 regardless of an actual value of the input values RGB.

The selection unit 130 may be configured to receive a selection of one of the methods M1a and M1b from the user. In the embodiment, the value of the K component in the input values RGB is calculated according to the method M1b.

Whether an input color represented by the input values Ri, Gi, and Bi corresponds to the primary color, the secondary color, or the tertiary color is also determined by the Ci, Mi, and Yi components. That is, when only one of the Ci, Mi, and Yi components obtained by converting any input values Ri, Gi, and Bi by the formulas (q1) to (q3) is not 0 and the other two color components are 0, the input color represented by the input values is the “primary color”. When only two color components of the Ci, Mi, and Yi components are not 0 and the other one color component is 0, the input color is the “secondary color”. When none of the Ci, Mi, and Yi components is 0, the input color is the “tertiary color”. As described above, even when the input color space is RGB, non-input-color removal can be executed on various input colors from the primary color to the tertiary color. In addition to the non-input-color removal, the specific multi-order color component can also be removed.

### Processing Procedure

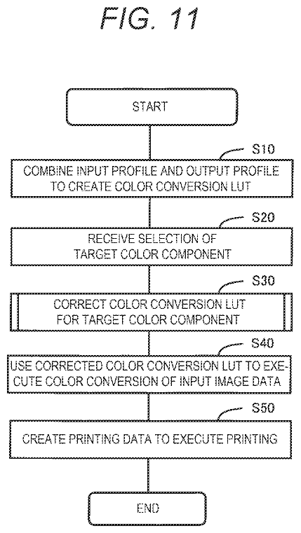

FIG. 11 is a flowchart showing an overall procedure of the color correction process. In step S10, the color conversion unit 110 combines the input profile IPF and the output profile OPF to create the color conversion lookup table 112. In step S20, the selection unit 130 receives, from the user, a selection of the target color component that is the target of the color correction. The target color component is selected using, for example, the selection window shown in FIG. 8. In step S30, the correction unit 120 corrects contents of the color conversion lookup table 112 for the target color component.

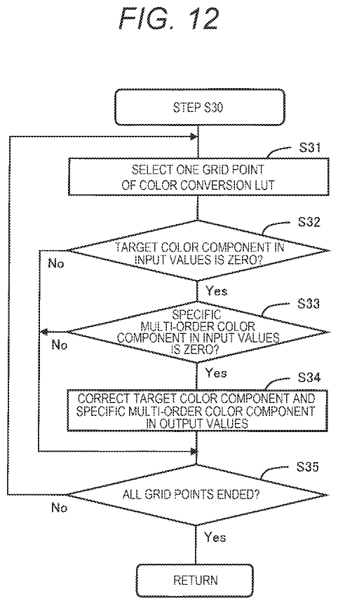

FIG. 12 is a flowchart showing a processing procedure of step S30 in the first embodiment. Here, it is assumed that the input color space is CMYK.

In step S31, the correction unit 120 selects one grid point of the color conversion lookup table 112. This process corresponds to a process of converting an input value in the input color space into an output value in the output color space. In step S32, the correction unit 120 determines whether the target color component in the input values CMYK of the selected grid point is 0. When the target color component is not 0 in the input values CMYK, the process proceeds to step S35 to be described later. On the other hand, when the target color component is 0 in the input values CMYK, the process proceeds to step S33, and the correction unit 120 determines whether the specific multi-order color component corresponding to the target color component whose input value is 0 in the input values CMYK is 0 in the input values. When the specific multi-order color component in the input value is not 0, the process proceeds to step S35 to be described later. On the other hand, when the specific multi-order color component in the input value is 0, the process proceeds to step S34, and the correction unit 120 corrects the target color component and the specific multi-order color component in the output values. That is, the target color component in the output values is corrected to 0 by applying the non-input-color removal, and the specific multi-order color component is corrected to 0. The correction unit 120 updates the output values of the color conversion lookup table 112 with the corrected output values. In step S35, the correction unit 120 determines whether the processes of steps S31 to S34 are completed for all grid points of the color conversion lookup table 112. When there is a grid point that is not processed, the process returns to step S31, and the processes of steps S31 to S34 are executed again. When the process is completed for all the grid points, the process of step S30 ends, and the process proceeds to step S40.

In step S40, the color conversion unit 110 uses the corrected color conversion lookup table 112 to execute a color conversion of the input image data IM. In step S50, the printing data generation unit 140 uses the color-converted image data to create printing data, and transfers the printing data to the printing device 400 to execute printing.

In the processing procedures in FIGS. 11 and 12 described above, the color correction is executed for the grid points of the color conversion lookup table 112, but instead, as shown in FIGS. 3 and 4, the color correction may be executed for an output of the color conversion unit 110 or an output of the color separation unit 142. When color correction is executed on the grid points of the color conversion lookup table 112, an appropriate color conversion can be executed on a large number of pieces of input image data using the corrected color conversion lookup table 112. When color correction is executed for the grid points of the color conversion lookup table 112, there is no need to perform color correction for each pixel of the input image data, so there is an advantage that a processing speed is faster.

According to the first embodiment described above, when the target color component is not in the color represented by the input value, the target color component in the output value is removed, and thus it is possible to prevent occurrence of color turbidity and graininess. In addition, even for a specific multi-order color component that is not selected as the target color component, the occurrence of color turbidity and graininess due to the specific multi-order color component can be prevented by decreasing the value of the output value. Since one or more target color components can be selected, a correction process can be executed for a desired number of target color components.

### Second Embodiment

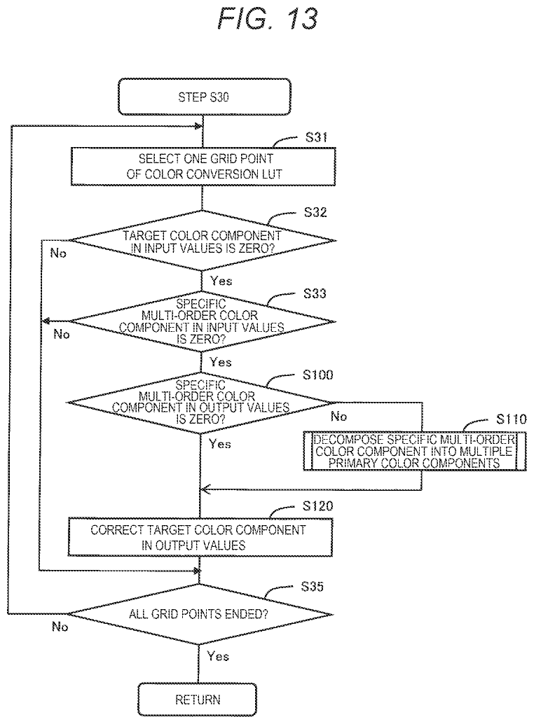

FIG. 13 is a flowchart showing a processing procedure of step S30 in a second embodiment. A device configuration shown in FIGS. 1 and 2 is the same as that of the first embodiment. The overall processing procedure shown in FIG. 11 is also the same as that in the first embodiment. In the processing procedure in FIG. 13, step S34 of the processing procedure shown in FIG. 12 is replaced with steps S100, S110, and S120, and other steps are the same as those in FIG. 12.

In step S100, the correction unit 120 determines whether the specific multi-order color component in the output value is 0. For example, when the output color space is CMYK, it is determined whether the K component which is the specific multi-order color component is 0. When the specific multi-order color component in the output value is 0, the process proceeds to step S120 to be described later. On the other hand, when the specific multi-order color component in the output value is not 0, the process proceeds to step S110, and the correction unit 120 decomposes the specific multi-order color component in the output value into a plurality of primary color components. The K component as the specific multi-order color component is decomposed into C, M, and Y components. Decomposition of the specific multi-order color component in step S110 is executed to reduce a change in color due to the decomposition. Specifically, for example, the values of the C, M, and Y components after the decomposition may be determined by adding the values of the K component to the C, M, and Y components, respectively. Alternatively, the value of the primary color component after the decomposition may be determined by the following procedure.

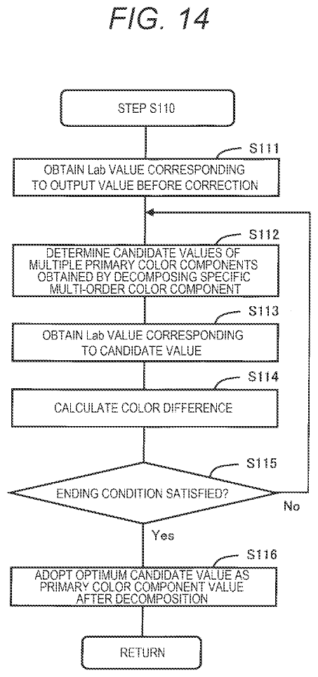

FIG. 14 is a flowchart showing a processing procedure of step S110 in the second embodiment. In step S111, the correction unit 120 obtains Lab values corresponding to the output values before correction. The “Lab value” means an L⁺a⁺b⁺ value in a CIE-L⁺a⁺b⁺ color system. The process of step S111 can be executed by an inverse conversion using the output profile OPF. In step S112, the correction unit 120 determines candidate values of a plurality of primary color components obtained by decomposing the specific multi-order color component. An initial value of the candidate value may be any value. In step S113, the correction unit 120 obtains a Lab value corresponding to the candidate value. This processing can also be executed by the inverse conversion using the output profile OPF. In step S114, the correction unit 120 calculates a color difference based on the Lab value obtained in step S111 and the Lab value obtained in step S113. In step S115, the correction unit 120 determines whether a preset ending condition is satisfied. As the ending condition, for example, a condition that the color difference is equal to or less than a preset allowable value can be used. Alternatively, a condition that the number of times of execution of the processes of steps S112 to S114 reaches a preset upper limit number of times or more may be used. When the ending condition is not satisfied, the process returns to step S112, and the processes of steps S112 to S115 are executed again. At this time, in step S112, a next candidate value is searched for. The search for the candidate value may be executed using an optimization algorithm. When the ending condition is satisfied, the process proceeds to step S116, and the correction unit 120 adopts an optimum candidate value as a value of the plurality of primary color components after the decomposition. As the “optimum candidate value”, for example, the smallest color difference is selected from among a plurality of candidate values.

By the process of step S110, the value of the specific multi-order color component in the output value becomes 0, and the values of the plurality of primary color components increase. The decomposition may increase the value of the target color component to be subjected to non-input-color removal. For example, when the C component is the target color component and the K component is the specific multi-order color component, the value of the K component becomes 0 by the process of step S110, the values of the C, M, and Y components increase, and the value of the C component which is the target color component also increases.

In the above-described process of FIG. 14, the values of the plurality of primary color components are determined so as to reduce the color difference. Alternatively, the values of the plurality of primary color components may be determined so as to reduce at least one difference among a saturation, a brightness, and a hue.

In step S120 of FIG. 13, the correction unit 120 corrects a target color component in the output values. That is, the target color component in the output values is corrected to 0 by applying the non-input-color removal. When the value of the target color component is increased by the decomposition of the specific multi-order color component in step S110, the target color component is also corrected to 0.

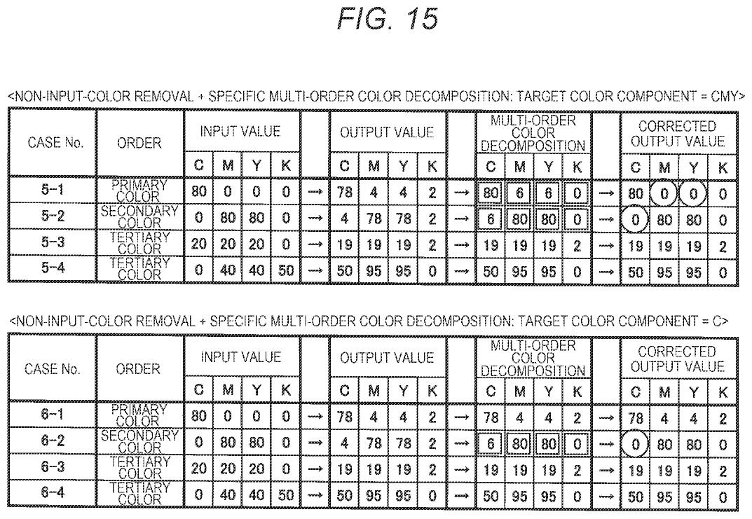

FIG. 15 is a diagram showing an example of a color correction process according to the second embodiment. This example corresponds to the result obtained by executing the correction according to step S110 and S120 in the processing example shown in FIG. 9. “Multi-order color decomposition” is an output value after the process in step S110, and the “corrected output value” is an output value after the process in step S120. Numbers surrounded by double frames in the “multi-order color decomposition” are values of the color components that are changed due to the decomposition of the specific multi-order color component. The primary color component increased by the decomposition is corrected to 0 by non-input removal related to the target color component in step S120.

As described above, when the specific multi-order color component is decomposed into a plurality of primary color components, it is possible to prevent the color from being excessively different due to the correction on the output value. This can be understood by, for example, comparing the corrected output value in the case 1-1 in FIG. 9 with the corrected output value in the case 3-1 in FIG. 15. The input values CMYK (80, 0, 0, 0) and the output values CMYK (78, 4, 4, 2) of the color conversion are the same in the two cases 1-1 and 5-1. The corrected output values are CMYK (78, 0, 0, 0) in the case 1-1, but are CMYK (80, 0, 0, 0) in the case 5-1. As described above, in the case 1-1 in which the specific multi-order color component is not decomposed, a density of a color represented by the corrected output value may be lower than a density of a color to be reproduced by the output value. Meanwhile, in the case 5-1 in which the specific multi-order color component is decomposed, the density of the color represented by the corrected output value can be made substantially the same as the density of the color to be reproduced by the output value. That is, it is possible to reduce a change in color due to the correction on the output value. In the embodiment, by removing the target color component after decomposing the specific multi-order color component, it is possible to further reduce color turbidity and graininess. As can be understood from the example of FIG. 15, the decomposition of the specific multi-order color component also corresponds to the “process of reducing the specific multi-order color component”.

The reason why the decomposition of the K component which is the specific multi-order color component is not performed in a case 5-3 is that, in step S32 of FIG. 15, it is determined that “the specific multi-order color component corresponding to the target color component whose input value is 0 is not 0 in the input values”, and the output values are not corrected. That is, in the input values CMYK (20, 20, 20, 0) in the case 5-3, the K component is 0, but the C, M, and Y components which are the primary color components are not 0, and thus the determination in step S32 is No, and the correction on the output value is not executed. When the specific multi-order color component is designated as the target color component, the input value of the target color component is 0, and the output value is not 0, when the target color component that is the specific multi-order color component is removed, the decomposition of the specific multi-order color component may be executed.

The second embodiment has a similar effect as the first embodiment. In the second embodiment, it is possible to reduce a change in color due to the correction on the output value.

### Third Embodiment

In the first and the second embodiment embodiment described above, the non-input-color removal is executed on the target color component, but in a third embodiment, non-input-color suppression is executed instead of the non-input-color removal. The “non-input-color suppression” is color correction in which a target color component that is not present in a color represented by an input value is reduced from an output value. In the non-input-color suppression, it is preferable to reduce a value of the target color component and change the value to a corrected value that is not zero. When the non-input-color removal is performed, a suppression process for reducing the specific multi-order color component is also applied.

The corrected value of the target color component after the non-input-color suppression is calculated by the following formula, for example.

$$Dc = min ( k 1 \times Do , Dmax ) \qquad ( q5 )$$

Here, Dc is a corrected value of the target color component, Do is a value of the target color component before correction, min ( ) is a function for selecting and outputting a smaller value, k1 is a positive coefficient less than 1, and Dmax is an upper limit value. The upper limit value Dmax is set in advance as a value at which color turbidity and graininess are not perceived. For a result of k1×Do, a rounding operation such as rounding up, rounding down, or rounding off to a digit after a decimal point may be applied. When rounding up is applied as the rounding operation, the corrected value Dc of the target color component can be a positive value other than 0. The suppression of the specific multi-order color component can also be performed by the following formula similar to the formula (q5).

$$Kc = min ( k 2 \times Ko , Kmax ) \qquad ( q6 )$$

Here, Kc is a corrected value of the specific multi-order color component, Ko is a value of the specific multi-order color component before correction, min ( ) is a function for selecting and outputting a smaller value, k2 is a positive coefficient less than 1, and Kmax is an upper limit value. The upper limit value Kmax is set in advance as a value at which color turbidity and graininess is not perceived. For a result of k2×Ko, a rounding operation such as rounding up, rounding down, or rounding off to a digit after a decimal point may be applied. The coefficient k2 and the upper limit value Kmax may be values same as the coefficient k1 and the upper limit value Dmax of the above formula (q5), or may be different values.

For example, it is assumed that the target color component is CMY, input values of a color conversion are CMYK (0, 80, 80, 0), and output values are CMYK (4, 78, 78, 2). In this case, when the non-input-color removal and the removal of the specific multi-order color component described in the first embodiment are applied, the corrected output value becomes CMYK (0, 78, 78, 0). Meanwhile, when the non-input-color suppression and the suppression of the specific multi-order color component in which k1=k2=0.5 and Dmax=Kmax=3 [%] are applied, the corrected output value becomes CMYK (2, 78, 78, 1), and the C component and the K component are reduced to values other than 0.

The upper limit values Dmax and Kmax at which color turbidity and graininess is not perceived may be stored in the output profile OPF. Alternatively, the upper limit values Dmax and Kmax may be acquired in association with the printing device 400, or may be set by a user. A manufacturer or a user of the printing device 400 can actually execute printing and set the upper limit values Dmax and Kmax evaluated as no problem.

When the non-input-color suppression is applied, and when a target color component is not in an input color, by reducing the target color component in an output color, it is possible to obtain a printed matter with less color turbidity and graininess. When the non-input-color removal and the removal of the specific multi-order color component described in the first embodiment are applied, the color difference between the input color and the output color may increase. Meanwhile, when the non-input-color suppression and the suppression of the specific multi-order color component are applied, the color difference between the input color and the output color can be reduced as compared with the case in which the non-input-color removal and the removal of the specific multi-order color component are applied. When the non-input-color suppression is applied, the decomposition of the specific multi-order color component described in the second embodiment may also be applied. In this case, since the specific multi-order color component is decomposed into a plurality of primary color components, the suppression of the specific multi-order color component is not executed. As a result, it is possible to reduce a change in color due to correction while preventing the occurrence of color turbidity and graininess.

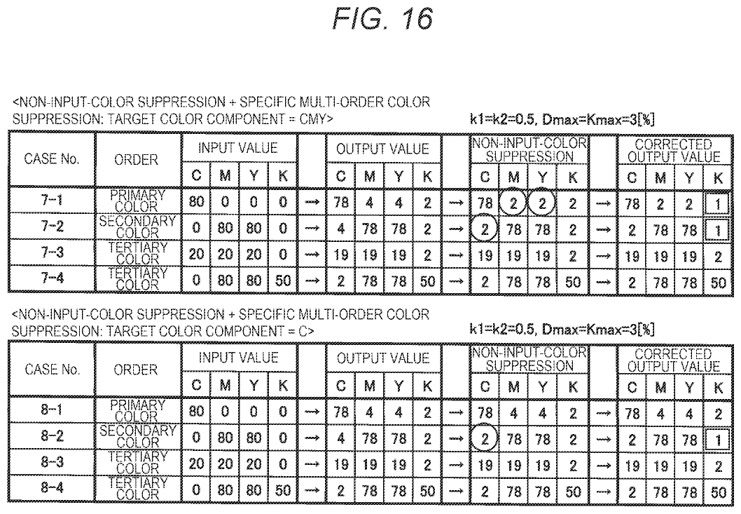

FIG. 16 is a diagram showing a processing example of non-input-color suppression when an input color space and an output color space are CMYK according to a third embodiment. A device configuration shown in FIGS. 1 and 2 is the same as that of the first embodiment. The overall processing procedure shown in FIG. 11 is also the same as that in the first embodiment. The example in FIG. 16 corresponds to a result of applying the non-input-color suppression according to the above formula (q5) and the suppression of the specific multi-order color component according to the above formula (q6) instead of the non-input-color removal and the removal of the specific multi-order color component in the example shown in FIG. 9. In this example, k1=k2=0.5 and Dmax=Kmax=3 [%].

The following formula may be used instead of the above formulas (q5) and (q6).

$$\begin{matrix}Dc = k 1 \times Do & ( q7 ) \\ Kc = k 2 \times Ko & ( q 8 )\end{matrix}$$

When using the formulas (q7) and (q8), it is possible to implement the non-input-color suppression and the suppression of the specific multi-order color component. Each of the above formulas (q5) and (q7) corresponds to a calculation for obtaining the corrected value Dc by multiplying the value Do of the target color component in the output values by the positive coefficient k1 less than 1. When the value of the target color component is corrected by such a calculation, it is possible to prevent occurrence of color turbidity and graininess, and it is possible to reduce a change in a color due to the correction of the output value. The same applies to the suppression of the specific multi-order color component.

According to the third embodiment, when the target color component is not in the color represented by the input value, the target color component in the output value is reduced, and thus it is possible to prevent occurrence of color turbidity and graininess, and it is possible to reduce a change in a color due to the correction of the output value.

### Other Aspects

The present disclosure is not limited to the embodiments described above, and can be implemented in various aspects without departing from the spirit of the present disclosure. For example, the present disclosure can be implemented in the following aspects. In order to solve a part of or all of problems of the present disclosure, or to achieve a part of or all of effects of the present disclosure, technical features of the embodiments described above corresponding to technical features in the following aspects can be replaced or combined as appropriate. Unless the technical features are explained as essential technical features in the specification, the technical features can be deleted as appropriate.

(1) According to a first aspect of the present disclosure, a color correction device is provided. The color correction device includes: a color conversion unit configured to convert an input value in an input color space into an output value in an output color space; a selection unit configured to receive a selection, as a target color component, of one or more color components among a plurality of color components used in a printing device; and a correction unit configured to correct the output value in a manner of reducing the target color component when the input value represents a color not including the target color component. The correction unit reduces, when a specific multi-order color component different from the target color component is not included in the input value and the specific multi-order color component is included in the output value, the specific multi-order color component in the output value.

According to the color correction device, when the target color component is not in the color represented by the input value, the target color component in the output value is reduced, and thus it is possible to prevent occurrence of color turbidity and graininess. Since one or more target color components can be selected, a correction process can be executed for a desired number of target color components.

(2) In the above color correction device, the target color component may be one or more of a cyan component, a magenta component, and a yellow component, and the specific multi-order color component may be a color component that indicates, as a single color, a multi-order color including two or more color components including the target color component.

According to the color correction device, it is possible to reduce a specific multi-order color component corresponding to a color material of a multi-order color such as a K (black) component or an R (red) component from an output value.

(3) In the above color correction device, the specific multi-order color component may be a black component.

According to the color correction device, it is possible to reduce a K (black) component from an output value.

(4) In the above color correction device, a process of reducing the specific multi-order color component in the output value may include a process of decomposing the specific multi-order color component into a plurality of primary color components.

According to the color correction device, since the specific multi-order color component is decomposed into the plurality of primary color components, it is possible to reduce a change in color due to the correction while preventing occurrence of color turbidity and graininess.

(5) In the above color correction device, the correction unit may not execute the correction on the output value when the specific multi-order color component is included in the input value.

According to the color correction device, the correction is skipped when an effect of reducing the color turbidity and the graininess is small, and thus the process can be speeded up.

(6) In the above color correction device, the correction of the output value of reducing the target color component may be a process of correcting the output value in a manner of changing a value of the target color component to a corrected value that is not zero.

According to the color correction device, it is possible to prevent a color from being excessively different due to correction.

(7) In the above color correction device, the color conversion unit may include a color conversion lookup table for converting the input color space into the output color space, and the correction unit may execute the correction on the color conversion lookup table.

According to the color correction device, it is possible to execute an appropriate color conversion using a corrected color conversion lookup table.

(8) In the above color correction device, the correction unit may select a grid point at which an input value component corresponding to the target color component is not present among a plurality of grid points of the color conversion lookup table, and correct an output value component corresponding to the target color component and the specific multi-order color component among the output values for the selected grid point.

According to the color correction device, it is possible to appropriately correct the output value at the grid point in the color conversion lookup table.

(9) According to a second aspect of the present disclosure, a printing system including a color correction device and a printing device is provided. The color correction device includes a color conversion unit configured to convert an input value in an input color space into an output value in an output color space, a selection unit configured to receive a selection, as a target color component, of one or more color components among a plurality of color components used in the printing device, a correction unit configured to correct the output value in a manner of reducing the target color component when the input value represents a color not including the target color component, and a printing data generation unit configured to generate printing data to be supplied to the printing device using a corrected output value corrected by the correction unit. The correction unit reduces, when a specific multi-order color component different from the target color component is not included in the input value and the specific multi-order color component is included in the output value, the specific multi-order color component in the output value.

(10) According to a third aspect of the present disclosure, a color correction method is provided. The color correction method includes: (a) converting an input value in an input color space into an output value in an output color space; (b) receiving a selection, as a target color component, of one or more color components among a plurality of color components used in a printing device; and (c) correcting the output value in a manner of reducing the target color component when the input value represents a color not including the target color component. The (c) includes reducing, when a specific multi-order color component different from the target color component is not included in the input value and the specific multi-order color component is included in the output value, the specific multi-order color component in the output value.

(11) According to a fourth aspect of the present disclosure, a non-transitory computer-readable storage medium storing a computer program is provided. The computer program causes a computer to execute: (a) a process of converting an input value in an input color space into an output value in an output color space; (b) a process of receiving a selection, as a target color component, of one or more color components among a plurality of color components used in a printing device; and (c) a process of correcting the output value in a manner of reducing the target color component when the input value represents a color not including the target color component. The process (c) includes a process of reducing, when a specific multi-order color component different from the target color component is not included in the input value and the specific multi-order color component is included in the output value, the specific multi-order color component in the output value.

The present disclosure can also be implemented in various forms other than the image processing device, the printing system, and the computer program. For example, the present disclosure can be implemented in the form of an image processing method or a non-transitory storage medium on which a computer program is recorded.

What is claimed is:

1. A color correction device comprising:
a color conversion unit configured to convert an input value in an input color space into an output value in an output color space;
a selection unit configured to receive a selection, as a target color component, of one or more color components among a plurality of color components used in a printing device; and
a correction unit configured to correct the output value in a manner of reducing the target color component when the input value represents a color not including the target color component, wherein
the correction unit reduces, when a specific multi-order color component different from the target color component is not included in the input value and the specific multi-order color component is included in the output value, the specific multi-order color component in the output value.

2. The color correction device according to claim 1, wherein
the target color component is one or more of a cyan component, a magenta component, and a yellow component, and
the specific multi-order color component is a color component that indicates, as a single color, a multi-order color including two or more color components including the target color component.

3. The color correction device according to claim 2, wherein
the specific multi-order color component is a black component.

4. The color correction device according to claim 1, wherein
a process of reducing the specific multi-order color component in the output value includes a process of decomposing the specific multi-order color component into a plurality of primary color components.

5. The color correction device according to claim 1, wherein
the correction unit does not execute the correction on the output value when the specific multi-order color component is included in the input value.

6. The color correction device according to claim 1, wherein
the correction of the output value of reducing the target color component is a process of correcting the output value in a manner of changing a value of the target color component to a corrected value that is not zero.

7. The color correction device according to claim 1, wherein
the color conversion unit includes a color conversion lookup table for converting the input color space into the output color space, and
the correction unit executes the correction on the color conversion lookup table.

8. The color correction device according to claim 7, wherein
the correction unit selects a grid point at which an input value component corresponding to the target color component is not present among a plurality of grid points of the color conversion lookup table, and corrects an output value component corresponding to the target color component and the specific multi-order color component among the output values for the selected grid point.

9. A printing system comprising:
a color correction device; and
a printing device, wherein
the color correction device includes
a color conversion unit configured to convert an input value in an input color space into an output value in an output color space,
a selection unit configured to receive a selection, as a target color component, of one or more color components among a plurality of color components used in the printing device,
a correction unit configured to correct the output value in a manner of reducing the target color component when the input value represents a color not including the target color component, and
a printing data generation unit configured to generate printing data to be supplied to the printing device using a corrected output value corrected by the correction unit, and
the correction unit reduces, when a specific multi-order color component different from the target color component is not included in the input value and the specific multi-order color component is included in the output value, the specific multi-order color component in the output value.

10. A color correction method comprising:
(a) converting an input value in an input color space into an output value in an output color space;
(b) receiving a selection, as a target color component, of one or more color components among a plurality of color components used in a printing device; and
(c) correcting the output value in a manner of reducing the target color component when the input value represents a color not including the target color component, wherein
the (c) includes reducing, when a specific multi-order color component different from the target color component is not included in the input value and the specific multi-order color component is included in the output value, the specific multi-order color component in the output value.

11. A non-transitory computer-readable storage medium storing a computer program, the computer program causing a computer to execute:
(a) a process of converting an input value in an input color space into an output value in an output color space;
(b) a process of receiving a selection, as a target color component, of one or more color components among a plurality of color components used in a printing device; and
(c) a process of correcting the output value in a manner of reducing the target color component when the input value represents a color not including the target color component, wherein
the process (c) includes a process of reducing, when a specific multi-order color component different from the target color component is not included in the input value and the specific multi-order color component is included in the output value, the specific multi-order color component in the output value.
